(19) United States
(12) Patent Application Publication
(10) Pub. No.: US 2016/0325517 A1
(43) Pub. Date: Nov. 10, 2016

(54) Systems and Methods for Forming Retread Tires Using Flat Backed Tread

(71) Applicant: BRIDGESTONE BANDAG, LLC, Muscatine, IA (US)

(72) Inventors: Terry A. Westaway, Conesville, IA (US); Robert G. Otting, Illinois City, IL (US)

(21) Appl. No.: 15/107,800

(22) PCT Filed: Dec. 16, 2014
(86) PCT No.: PCT/US2014/070471

§ 371 Date: Jun. 23, 2016

Related U.S. Application Data
(60) Provisional application No. 61/921,139, filed on Dec. 27, 2013.

(51) Int. Cl. B29D 30/56; B60C 11/02

(52) U.S. Cl. CPC B29D 30/56; B60C 11/02; B29D 2030/541

(57) ABSTRACT

Retreaded tires and methods for manufacturing the same. A tire is retreaded with a pre-cured tread band having a smooth back face and one or more tread grooves with compliant skid base gauge on a front face. The grooves in the pre-cured tread band align with grooves in a tire casing and upon curing conform to the shape of the casing grooves. The tire tread depths are greater than the original tire tread depth of the pre-cured tread band, thereby increasing the wear volume of the tire tread.

### BACKGROUND

The present disclosure relates generally to tire retreading, and more particularly to systems and methods for retreading a tire and manufacturing a retreaded tire.

When a tire becomes worn, worn tread can be replaced using a process known as retreading. Such retreading can include a mechanical buffing process to remove worn tire tread from the tire casing. The buffing process allows for the tire casing to be buffed to a desired size, shape and texture. A tire tread can then be applied to the buffed casing. For example, a pre-cured tire tread having a desired tread design on an outer surface can be applied or positioned on the buffed casing. An adhesive layer such as an uncured rubber compound may be applied between the tread and the casing to facilitate adhesion between the tread and the casing. The assembly, including the casing and the tread, may then be cured or vulcanized in a curing chamber such as an autoclave. A retreaded tire may thereby be manufactured.

Retreading processes have involved bonding a tread to a tire casing that is buffed flat or with a continuously arched profile. The tread includes a front face that contacts the ground and provides traction, and a back face that may be bonded to the tire casing. Grooves may be provided in the front face of the tread as part of the tread design.

The tire tread volume needed to produce a retreaded tire with sufficient tread groove depth can be a significant cost. As such it is desirable to reduce the volume of material needed for a tire tread, yet maintain or even improve the wear volume of the tire tread (e.g., usable volume of tread material that may be worn until the depth of the exposed tread grooves is reduced to a point that the tire needs to be taken out of service and discarded or retreaded). Accordingly, it is desirable to provide retreaded tires having optimized tread wear volume and compliant tread groove depth, as well as systems and methods for manufacturing retreaded tires with optimized tread wear volume and compliant tread groove depth.

### BRIEF SUMMARY

The present disclosure relates generally to tire retreading, and more particularly to systems and methods for retreading a tire and manufacturing a retreaded tire. For example, in certain embodiments, systems and methods are provided for retreading a tire using a pre-cured tread band having a substantially smooth back face and one or more tread grooves on a front face. The grooves in the pre-cured tread band align with grooves in a tire casing and, in the process of curing, the substantially smooth back face may conform to the shape of the casing groove thereby forming a synergistic new groove. The retreaded tires advantageously have compliant skid base gauges with tire tread depths greater than the original tire tread depth of the pre-cured tread band, thereby increasing the wear volume of the tire tread.

According to one aspect, a method of retreading a tire is provided. The method may include providing a tire casing having a casing profile with at least one casing groove, the at least one casing groove having a casing groove depth and a casing groove shape, and providing a tire tread having a substantially smooth profile on a back side and at least one tread groove on a front side, the at least one tread groove having an initial tread groove depth. The method may also include aligning the tire tread on the tire casing to produce a tire assembly, wherein the substantially smooth profile on the back side of the tire tread faces the tire casing and wherein the at least one tread groove on the front side of the tire tread aligns with the at least one casing groove, and curing the tire assembly under pressure such that the back side of the tire tread conforms to at least a portion of the casing profile whereby the at least one tread groove conforms to the casing groove depth and the casing groove shape such that a final depth of the tread groove is greater than the initial tread groove depth.

According to one aspect, a method of retreading a tire is provided. The method may include providing a tire casing having a casing profile with at least one casing groove, the at least one casing groove having a casing groove depth and a casing groove shape, and providing a tire tread having at least one tread groove on a front side, the at least one tread groove having an initial tread groove depth, the back side having a substantially smooth profile in a region proximal to a bottom of the at least one tread groove. The method may also include aligning the tire tread on the tire casing to produce a tire assembly, wherein the substantially smooth profile on the back side of the tire tread faces the tire casing and wherein the at least one tread groove on the front side of the tire tread aligns with the at least one casing groove, and curing the tire assembly under pressure such that the back side of the tire tread conforms to at least a portion of the casing profile whereby the at least one tread groove conforms to the casing groove depth and the casing groove shape such that a final depth of the tread groove is greater than the initial tread groove depth.

According to another aspect, a retreaded tire is provided. The retreaded tire may include a tire casing with sidewalls, and a tire tread cured to the tire casing, the tire tread having a final tread groove depth greater than an initial tire tread groove depth, where the tire tread has been joined to the tire casing by curing a tire assembly under elevated pressure and temperature. In curing, the assembly may have included at least a tire casing component and a tire tread component, the tire tread component having had a substantially smooth profile on a back side and at least one tread groove on a front side with an initial tire tread groove depth, and the tire casing component having had a casing profile with at least one casing groove with a casing groove depth, and where the substantially smooth back side of the tire tread component faced the tire casing component and where the at least one tread groove was aligned with the at least one casing groove.

According to yet another aspect, a system for retreading a tire casing is provided. The system may include a vessel, a pressure source operable to increase pressure within the vessel, a heat source operable to increase a temperature within the vessel, and a tire assembly. The tire assembly may include a tire tread having a substantially smooth back side and at least one tread groove on a front side with an initial tread groove depth, and a tire casing having a casing profile with at least one casing groove with a casing groove depth. In operation, the tire tread may be positioned on the tire casing such that the substantially smooth back side of the tire tread faces the tire casing and wherein the at least one tread groove is aligned with the at least one casing groove. The tire tread may be configured such that, when the pre-cured tire assembly is provided in the vessel and the pressure and temperature are increased, the tread back side will conform to the casing profile and the shape of the casing groove in a manner such that a final depth of the tread groove is greater than the initial tread groove depth.

Reference to the remaining portions of the specification, including the drawings and claims, will realize other features and advantages of the present disclosure. Further features and advantages of the present disclosure, as well as the structure and operation of various embodiments of the present disclosure, are described in detail below with respect to the accompanying drawings. In the drawings, like reference numbers indicate identical or functionally similar elements.

### BRIEF DESCRIPTION OF THE DRAWING(S)

FIG. 1 illustrates a partial cross-sectional view of separated components of a tire assembly according to an embodiment.

FIG. 2 illustrates a partial cross sectional view of tire assembly prior to curing, according to an embodiment.

FIG. 3 illustrates a partial cross sectional view of a retreaded tire after the tire assembly of FIG. 2 is cured, according to an embodiment.

FIG. 4 illustrates a method of retreading a tire according to an embodiment.

### DETAILED DESCRIPTION

Retreaded tires and methods for forming the same are described. According to certain example embodiments, a tire is retreaded with a tread band having a substantially smooth back face and one or more tread grooves with compliant skid base gauge on a front face. The grooves in the tread band are operable to align with grooves in a tire casing and upon curing may conform to the shape of the casing grooves. Retreaded tires advantageously may have compliant skid base gauges with groove depths greater than the original groove depth of the tread band, thereby increasing the wear volume of the tire tread. In certain aspects, the tread band may be pre-cured, and in other aspects, the tread band may be uncured. In general, the present disclosure is applicable to any type of retreading process.

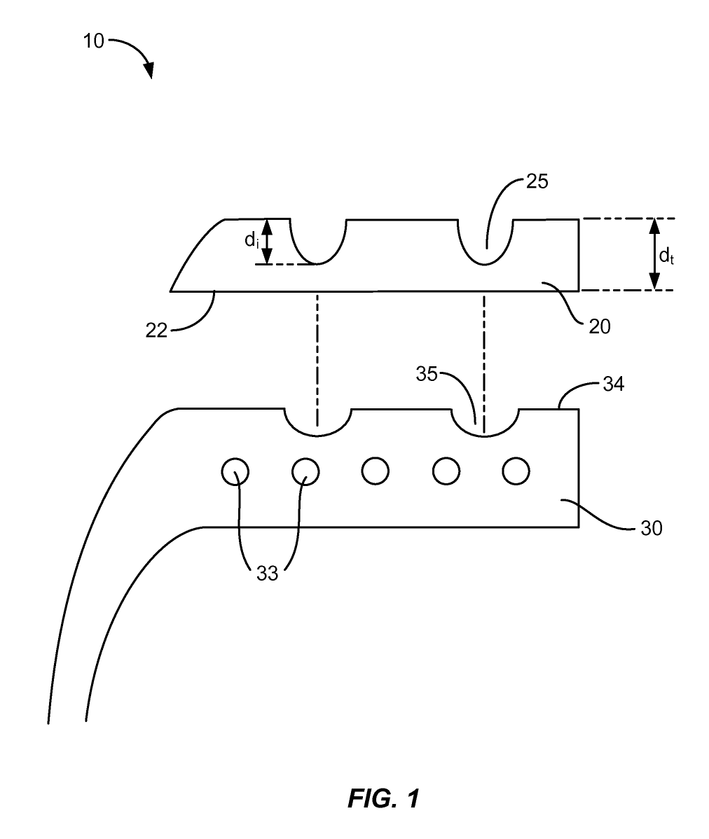

FIG. 1 illustrates a partial cross-sectional view of separated components of a tire assembly 10 according to an embodiment. Tire assembly 10 includes a tread 20 and a tire casing 30. Tire casing 30 includes a buffed front face 34 having one or more pre-formed grooves 35. Grooves 35 may include pre-existing grooves in the casing, or they may be created during a buffing process. The grooves are depicted with a curved profile, although other profiles are possible as would be understood, such as rectangular, triangular, polygonal, etc. Tire casing 30 also typically includes a wire band including one or more wires or belts 33 embedded in the casing. Tire tread 20 has a substantially smooth back face 22 and one or more tread grooves 25 on a front face 24. It should be understood that the terms “face” and “side” are used interchangeably herein when discussing tire components such as a tire tread. Each tread groove 25 has a tread profile including an initial tread groove depth, dᵢ. Similar to the casing grooves, the tread grooves are depicted with a curved profile, although other profiles are possible as would be understood, such as rectangular, triangular, polygonal, etc. Moreover, while the groove profiles are shown to coincide (e.g., both are curved), the grooves may be of other profile combinations still aligning with each other. The initial tread groove depth, dᵢ, is less than the tread band depth or thickness, dₜ, as shown (not to scale), where the difference, dₜ-dᵢ, will typically be in the range near 1/32″.

Where more than one tread groove is present, each groove may have the same profile (cross sectional shape and initial tread groove depth), or some or all tread grooves may have different profiles. In certain aspects, the one or more tread grooves are circumferential grooves, e.g., running parallel to a centerline of the tire. The one or more tread grooves may include lateral tread grooves, e.g., grooves having a directional component at an angle between about 1° and 90° (fully perpendicular to the centerline) with respect to the centerline of the tire. It should be appreciated that the profile of a particular tread groove may change along a length of the groove.

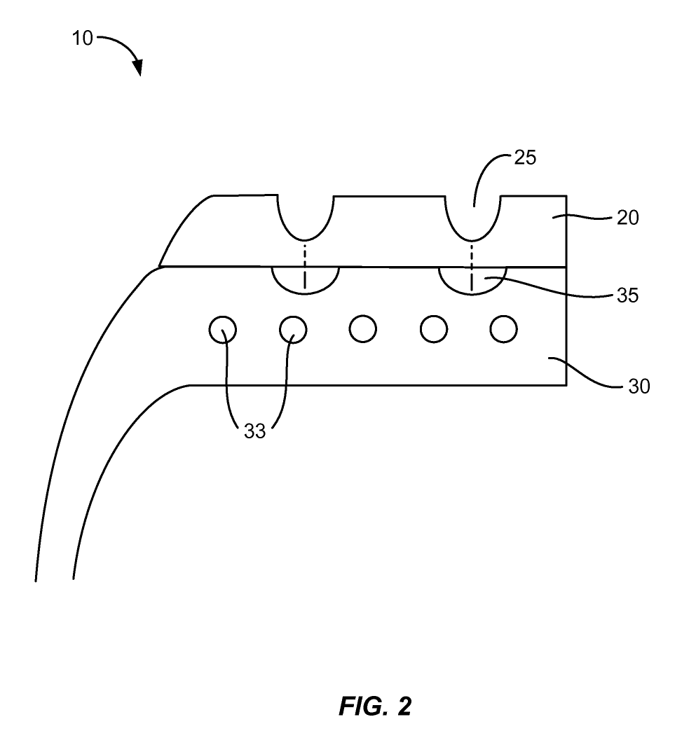

FIG. 2 illustrates a partial cross sectional view of tire assembly 10 prior to curing according to an embodiment. As shown, tread 20 is positioned on casing 30 such that the substantially smooth back face 22 of tread 20 faces the exposed front face of the tire casing 30 with the one or more tread grooves 25 aligned with the one or more casing grooves 35 in the buffed tire casing 30. For example, a centerline of a groove having a symmetrical profile is substantially aligned with a centerline of a symmetrical casing groove as shown (dotted line). A bonding layer (not shown) may be provided between tire tread 20 and tire casing 30. The bonding layer may include a rubber compound or cement layer that facilitates bonding of the tread to the casing as is well known. Examples of useful materials for the bonding layer include uncured rubber compounds and mixtures thereof. As shown in FIG. 2, when tread 20 is positioned and aligned, one or more gaps or spaces are present between the back face 22 and tread 20, and are defined by the casing groove(s) 35.

A substantially smooth back face includes a back face surface that has some amount of roughness or granularity as determined by the rubber composition used and the extruding process used to create the tread band, and any pre-assembly processing and the like. In general, the entire back side 22 may be flat (e.g., by comparison to the casing including the noted groove(s)) when positioned on a flat surface, however, due to the flexibility of rubber materials typically used, the substantially smooth back will bend to accommodate a curved surface, e.g., a curved casing profile. The substantially smooth back side generally has a smooth and continuous surface contour over the entire profile of the tread or in a region proximal to the bottom of the at least one tread grooves. The substantially smooth region is preferred devoid of protrusions extending from the back side, e.g., no pre-molded shapes or discontinuous surface features on the back side in proximity of the tread groove. It should be appreciated that a substantially smooth back face does not preclude intentional protrusions or grooves in the back face that do not interfere with the tread groove and casing groove alignment, e.g., an alignment feature or protrusion, which extends outward or inward from the back face 22 and which may be positioned to facilitate attachment or alignment of the tire tread on the casing by mating with a complementary groove or feature on the casing, may be present away from the groove alignment region(s). Similarly, other contours may be provided apart from portions aligning with the grooves in the casing such as described in U.S. Pat. No. 5,277,727, which is hereby incorporated by reference. Hence, a substantially smooth profile on the back side of a tread may include a surface contour that is substantially flat with no discontinuities, and it may include a curved surface with no discontinuities present, or it may include a flat or curved surface contour with discontinuities in regions away from where a tread groove conforms to a casing groove.

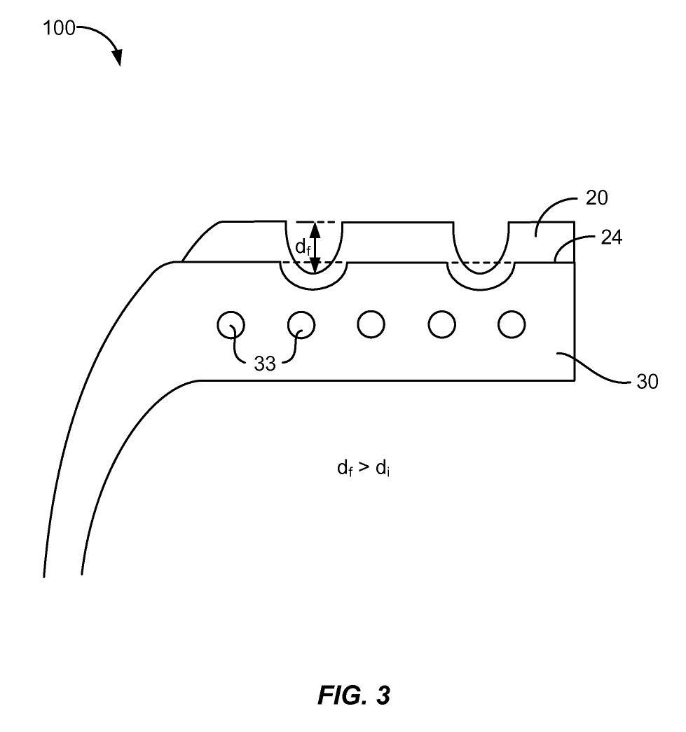

The tire assembly 10 shown in FIG. 2 is subjected to a curing process as will be described in more detail below. FIG. 3 illustrates a partial cross sectional view of a retreaded tire 100 after tire assembly 10 of FIG. 2 is cured, according to an embodiment. Retreaded tire 100 includes a tread groove having a final tread groove depth, d_{f}, that is greater than the initial groove depth, dᵢ, of tire tread 20

During the curing process, the bottom portion of the tread groove 22 conforms to the profile of the casing groove 35. Due to the increased pressure during curing, the bottom portion of the tread groove experiences a negative deformation or distortion and moves down into the casing groove, and the tread groove depth increases; the rubber material at the tread groove bottom, having a thickness dₜ-dᵢ, may also become thinner to some extent sometimes following Poisson's ratio such that the tread groove depth increases further.

The casing groove depth may be any depth as is practicable given the particular application. In certain aspects, for example, the desired casing groove depth is less than about 5/32″, e.g., between about 2/32″ and about 5/32″ for standard truck tires. Optimally, the casing groove depth is about 3/32″. Depending on the depth of the casing groove, dᵢ, the final tread groove depth will increase relative to the initial tread groove depth. For example, where the casing groove depth is approximately 3/32″ deep, the tread groove depth may increase by about 2/32″ or more, depending in part on the various system parameters, such as the mechanical properties of the rubber composition of the tire tread as well as the pressure and temperature at which the tire assembly is cured. For example, an initial tread groove depth of about 14/32″ may increase to about 16/32″. For a casing groove depth of about 3/32″, tread grooves having initial depths of between about 9/32″ and about 26/32″ may increase to between about 11/32″ and about 28/32″.

Various embodiments allow for the wear volume of a tire tread to be increased. For example, where a flat back tire tread is cured to a flat casing profile, the final tread groove depth will be substantially the same as the initial tread groove depth. As can be seen in FIG. 3, according to an embodiment, the final tread depth d_{f} can extend below the casing face 24. The entire volume of the tread therefore becomes part of the wear volume for the end user, i.e., the wear volume can be more efficient. As the tire tread wears during use, the life of the tire tread is extended, and indeed the rubber of the tire casing could be used as part of the wear volume as the tread becomes completely worn out with skid base gauge remaining. In this manner, a substantially smooth back tread product, such as a flat back tread product, having a reduced tread volume can be used to produce a retreaded tire having the same or a greater tread groove depth as compared with prior processes using a tread product having more tread volume yet with the same initial and final tread groove depth. This permits less of the tire casing to be buffed away during the retreading process, thereby conserving materials. This can provide a cost savings due to reduced material volume needed to create a desired usable tread groove depth in a retreaded tire.

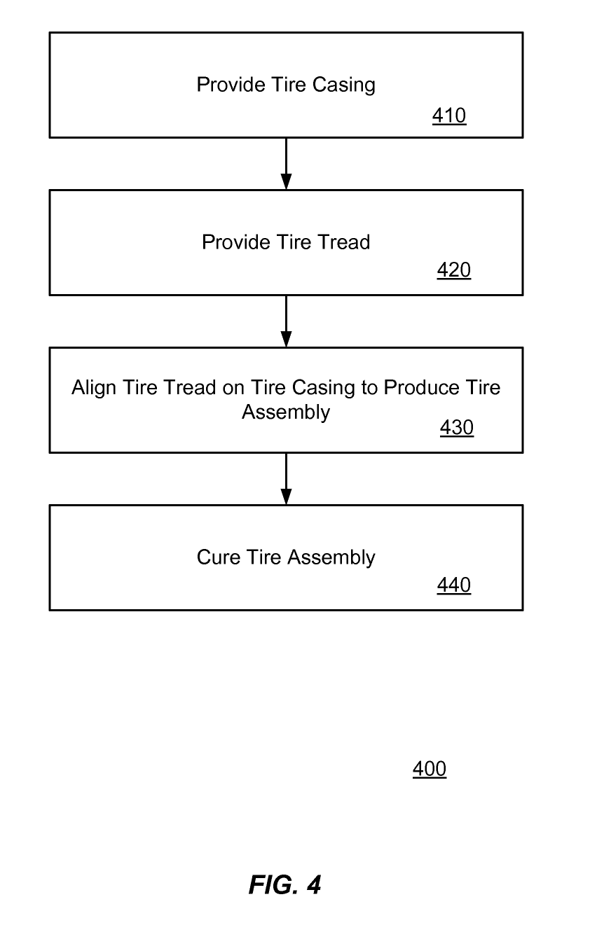

FIG. 4 illustrates a method 400 of retreading a tire according to an embodiment. In step 410 a tire casing is provided. The tire casing may be provided pre-buffed with a desired shape, or it may be buffed to remove any worn tread, and shaped as desired. For example, a tire casing may be buffed to produce a casing profile with at least one casing groove having a specified groove depth and a casing groove shape. In step 420, a tire tread is provided, which has a substantially smooth profile on a back side and a tread groove pattern having at least one tread groove on a front side. The at least one tread groove has an initial tread groove depth, dᵢ.

In step 430, the tire tread is placed or positioned on the tire casing such that the substantially smooth profile on the back side of the tire tread faces the tire casing and the at least one tread groove on the front side of the tire tread is aligned with the at least one casing groove. The alignment step 430 produces a tire assembly. A step of applying or placing a bonding material between the tire casing and the tire tread may be performed prior curing, e.g., prior to alignment step 430. The bonding material facilitates attachment or bonding of the tire tread to the casing during the curing process. In step 440, the tire assembly is cured. For example, the tire assembly is cured under pressure in a chamber or vessel such as an autoclave. The chamber or vessel may have a pressure source operable to adjust the pressure within the vessel and a heat source operable to adjust the temperature within the vessel. Curing typically includes increasing the pressure and the temperature within the curing chamber or vessel. In association with the curing process, the back side of the tire tread conforms to the casing profile. For example, the at least one tread groove conforms to the casing groove depth and the casing groove shape such that the final depth, d_{f}, of the tread groove is greater than the initial tread groove depth, dᵢ.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the embodiments (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All method or process steps described herein can be performed in any suitable order unless otherwise indicated herein or otherwise clearly contradicted by context. The use of any and all examples, or exemplary language (e.g., “such as”) provided herein, is intended merely to better illuminate the various embodiments and does not pose a limitation on the scope of the various embodiments unless otherwise claimed. No language in the specification should be construed as indicating any non-claimed element as essential to the practice of the various embodiments.

Exemplary embodiments are described herein, including the best mode known to the inventors. Variations of those embodiments may become apparent to those of ordinary skill in the art upon reading the foregoing description. The inventors expect skilled artisans to employ such variations as appropriate, and the inventors intend for the embodiments to be practiced otherwise than as specifically described herein. Accordingly, all modifications and equivalents of the subject matter recited in the claims appended hereto are included as permitted by applicable law. Moreover, any combination of the above-described elements in all possible variations thereof is encompassed unless otherwise indicated herein or otherwise clearly contradicted by context.

1. A method of retreading a tire, the method comprising:
providing a tire casing having a casing profile with at least one casing groove, said at least one casing groove having a casing groove depth and a casing groove shape;
providing a tire tread having a substantially smooth profile on a back side and at least one tread groove on a front side, the at least one tread groove having an initial tread groove depth;
aligning the tire tread on the tire casing to produce a tire assembly, wherein the substantially smooth profile on the back side of the tire tread faces the tire casing and wherein the at least one tread groove on the front side of the tire tread aligns with the at least one casing groove;
curing the tire assembly under pressure such that the back side of the tire tread conforms to at least a portion of the casing profile whereby the at least one tread groove conforms to the casing groove depth and the casing groove shape such that a final depth of the tread groove is greater than the initial tread groove depth.

2. The method recited in claim 1, wherein the at least one casing groove and the at least one tread groove are circumferential grooves, and wherein the tire tread includes at least one lateral groove.

3. The method recited in claim 1, further including buffing a tire casing to produce the tire casing having the casing profile with at least one casing groove.

4. The method recited in claim 1, further including placing a bonding material between the tire casing and the tire tread prior to curing.

5. The method recited in claim 4, wherein curing under pressure includes increasing pressure and temperature so that the bonding material facilitates attachment of the tire tread to the tire casing.

6. The method recited in claim 1, wherein a thickness of the tire tread groove between a bottom of the tire tread groove and the back side becomes thinner as the tread back side conforms to the casing profile.

7. The method recited in claim 1, wherein the casing groove depth is less than about 5/32″.

8. The method recited in claim 7, wherein the final depth of the tread groove is between about 11/32″ and 28/32″.

9. The method recited in claim 7, wherein the initial tread groove depth is about 14/32″ and wherein the final depth of the tread groove is about 16/32″.

10. A retreaded tire comprising:
a tire casing including sidewalls;
a tire tread cured to the tire casing, the tire tread having a final tread groove depth greater than an initial tire tread groove depth,
wherein the tire tread has been joined to the tire casing by curing a tire assembly under pressure, such assembly having included at least a tire casing component and a tire tread component, the tire tread component having had a substantially smooth profile on a back side and at least one tread groove on a front side with an initial tire tread groove depth, and the tire casing component having had a casing profile with at least one casing groove with a casing groove depth, and wherein the substantially smooth back side of the tire tread component faced the tire casing component and wherein the at least one tread groove was aligned with the at least one casing groove.

11. The retreaded tire recited in claim 10, wherein the tire assembly was cured under pressure, wherein the tread back side conformed to the casing profile whereby the at least one tread groove conformed to the shape of the casing groove such that the final tread groove depth is greater than the pre-assembly tread groove depth.

12. The retreaded tire recited in claim 10, wherein the tire assembly included a bonding material between the tire tread and the tire casing when the tire assembly was cured under pressure.

13. The retreaded tire recited in claim 10, wherein the casing groove depth is less than about 5/32″, wherein the pre-assembly tire tread groove depth is between about 9/32″ and about 26/32″, and wherein the final tread groove depth is between about 11/32″ and 28/32″.

14. The retreaded tire recited in claim 10, wherein the pre-assembly tire tread groove depth is about 14/32″ and wherein the final tread groove depth is about 16/32″.

15. The retreaded tire recited in claim 10, wherein the at least one casing groove and the at least one tread groove are circumferential grooves, and wherein the tire tread includes at least one lateral groove.

16. A system for retreading a tire, the system comprising:
a vessel;
a pressure source operable to increase pressure within the vessel;
a heat source operable to increase a temperature within the vessel; and
a tire assembly including:
a tire tread having a substantially smooth back side and at least one tread groove on a front side, the at least one tread groove having an initial tread groove depth, and
a tire casing having a casing profile with at least one casing groove, said at least one casing groove having a casing groove depth, and
wherein the tire tread is operable to be positioned on the tire casing such that the substantially smooth back side of the tire tread faces the tire casing and the at least one tread groove is aligned with the at least one casing groove; and
wherein the tire tread is configured such that, when the pre-cure tire assembly is provided in the vessel and the pressure and temperature are increased, the tread back side is operable to conform to the casing profile and the shape of the casing groove in a manner such that a final depth of the tread groove is greater than the initial tread groove depth.

17. The system recited in claim 16, wherein the vessel is an autoclave.

18. The system recited in claim 16, wherein the casing groove depth is less than about 5/32″, wherein the initial tread groove depth is between about 9/32″ and about 26/32″, and wherein the final depth of the tread groove is between about 11/32″ and 28/32″.

19. The system recited in claim 16, wherein the initial tread groove depth is about 14/32″ and wherein the final depth of the tread groove is about 16/32″.

20. The system recited in claim 16, wherein the at least one casing groove and the at least one tread groove are circumferential grooves, and wherein the tire tread includes at least one lateral groove.
